(19) United States
(12) Patent Application Publication
(10) Pub. No.: US 2015/0349545 A1
(43) Pub. Date: Dec. 3, 2015

(54) APPARATUS FOR WIRELESSLY TRANSMITTING POWER

(71) Applicant: HITACHI-LG DATA STORAGE KOREA, INC., Seoul (KR)

(72) Inventors: Hyunmin LEE, Seoul (KR); Kangnyung LEE, Seoul (KR); Hyunsuk HAN, Seoul (KR)

(73) Assignee: HITACHI-LG DATA STORAGE KOREA, INC., Seoul (KR)

(21) Appl. No.: 14/728,175

(22) Filed: Jun. 2, 2015

(30) Foreign Application Priority Data
Jun. 3, 2014 (KR) 10-2014-0067950

(51) Int. Cl. H02J 5/00; H02J 7/02; H02J 17/00

(52) U.S. Cl. CPC H02J 5/005; H02J 17/00; H02J 7/025

(57) ABSTRACT

Disclosed herein is an apparatus for wirelessly transmitting power. The apparatus for wirelessly transmitting power includes a transmission coil configured to change a magnetic field in response to an AC current, a shielding unit configured to restrict the propagation of the magnetic field generated from the transmission coil, and a casing configured to surround the transmission coil and the shielding unit. The transmission coil is formed in a single layer form by winding a wire along the sides of an isosceles triangle having a height greater than a base in the same plane, and the transmission coil may have a perimeter height of 52±0.5 mm, an inside height of 34±0.5 mm, a perimeter width of 46±0.5 mm, an inside width of 28±0.5 mm, and a thickness of 1.1±0.3 mm. The transmission coil may be formed by winding the wire on the sides of the isosceles triangle eight times.

### CROSS-REFERENCE TO RELATED APPLICATION

Pursuant to 35 U.S.C. §119(a), this application claims the benefit of earlier filing date and right of priority to Korean Patent Application No. 10-2014-0067950, filed on Jun. 3, 2014, the contents of which are incorporated by reference herein in their entirety.

### BACKGROUND OF THE INVENTION

1. Field of the Invention

The present invention relates to an apparatus for wirelessly transmitting power.

2. Discussion of the Related Art

With the recent development of communication and information processing technologies, the use of smart terminals, such as smart phones, is gradually increased. A charging method commonly applied to the smart terminal is a method of directly connecting an adaptor, connected to a power source, to the smart terminal and charging the smart terminal using external power or a method of connecting the adaptor to the smart terminal through the USB terminal of a host and charging the smart terminal using the USB power of the host.

In order to reduce inconvenience in which the smart terminal must be directly connected to the adaptor or the host through a connection line, recently, a wireless charging method of wirelessly charging the battery using magnetic coupling without an electrical contact is gradually applied to smart terminals.

There are some methods for wirelessly supplying or receiving electric energy. Representative methods include an inductive coupling method based on an electromagnetic induction phenomenon and an electromagnetic resonance coupling method based on an electromagnetic resonance phenomenon according to a wireless power signal of a specific frequency.

Both the methods can secure the stability of power transfer and improve transfer efficiency by forming a communication channel between a wireless charging device and an electronic device, such as a smart terminal, and exchanging data. The inductive coupling method is problematic in that transfer efficiency is deteriorated because a power reception apparatus moves while power is wirelessly transmitted, and the electromagnetic resonance coupling method is problematic in that the transfer of power is stopped because a noise is generated in a communication channel.

The electromagnetic resonance coupling method needs some time for commercialization, and standardization therefor is proceeding slowly. In contrast, standardization and commercialization for the inductive coupling method are proceeding rapidly.

In the inductive coupling method, charging is smoothly performed when a device to be charged, that is, a reception apparatus, is well matched with the center of a charger, that is, a transmission apparatus. For this reason, in some products, the centers of the transmission apparatus and reception apparatus are matched by an auxiliary magnet. Accordingly, there is a need for a transmission apparatus that enables charging or does not deteriorate efficiency although the centers of an apparatus for wirelessly transmitting power and a reception apparatus are not well matched.

### SUMMARY OF THE INVENTION

An object of the present invention is to improve transfer efficiency of an apparatus for wirelessly transmitting power.

Another object of the present invention is to improve the characteristics of a transmission coil in an apparatus for wirelessly transmitting power using the inductive coupling method.

Yet another object of the present invention is to propose an effective shape and size of the Tx coil in the apparatus for wirelessly transmitting power using the inductive coupling method.

In accordance with an embodiment of the present invention, there is provided an apparatus for wirelessly transmitting power, including a transmission coil configured to change a magnetic field in response to an AC current, a shielding unit configured to restrict the propagation of the magnetic field generated from the transmission coil, and a casing configured to surround the transmission coil and the shielding unit. The transmission coil is formed in a single layer form by winding a wire along sides of an isosceles triangle having a height greater than a base in an identical plane, and the transmission coil has a perimeter height of 52±0.5 mm, an inside height of 34±0.5 mm, a perimeter width of 46±0.5 mm, an inside width of 28±0.5 mm, and a thickness of 1.1±0.3 mm.

In an embodiment, the transmission coil may be formed by winding the wire on the sides of the isosceles triangle eight times.

In an embodiment, at least part of the shielding unit may be configured to exceed a perimeter of the transmission coil.

In an embodiment, the shielding unit may be formed between the transmission coil and the casing.

In accordance with another embodiment of the present invention, a transmission coil is configured to change a magnetic field in response to an AC current and wirelessly send power. The transmission coil may be formed in a single layer form by winding a wire along sides of an isosceles triangle having a height greater than a base in an identical plane, the transmission coil may have a perimeter height of 52±0.5 mm, an inside height of 34±0.5 mm, a perimeter width of 46±0.5 mm, an inside width of 28±0.5 mm, and a thickness of 1.1±0.3 mm, and the wire may be wound on the sides of the isosceles triangle eight times.

### BRIEF DESCRIPTION OF THE DRAWINGS

FIG. 1 is a conceptual diagram illustrating an example in which power is wirelessly transmitted from an apparatus for wirelessly transmitting power to an electronic device;

FIG. 2 is a conceptual diagram illustrating the configuration of a circuit in the power conversion unit of an apparatus for wirelessly transmitting power using an electromagnetic induction method;

FIG. 3 illustrating the configuration for exchanging power and messages between the apparatus for wirelessly transmitting power and a reception apparatus;

FIG. 4 is a block diagram illustrating a loop for controlling the transfer of power between the apparatus for wirelessly transmitting power and the reception apparatus;

FIG. 5 illustrates a transmission coil to which an embodiment of the present invention is applied; and

FIG. 6 is an exploded perspective view of a charger including the Tx coil of FIG. 5.

### DETAILED DESCRIPTION OF THE EMBODIMENTS

Hereinafter, apparatuses for wirelessly transmitting power in accordance with embodiments of the present invention are described in detail with reference to the accompanying drawings.

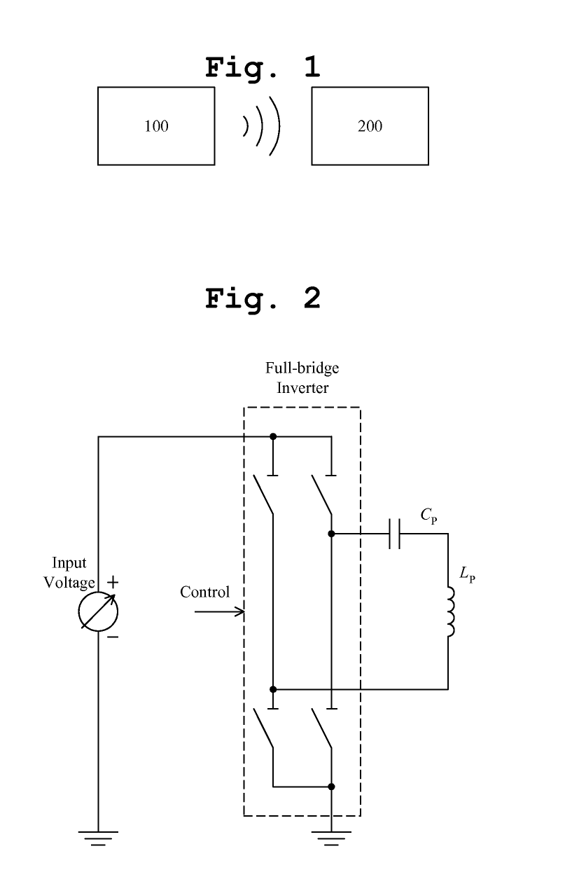

FIG. 1 is a conceptual diagram illustrating an example in which power is wirelessly transmitted from an apparatus for wirelessly transmitting power to an electronic device.

The apparatus 100 for wirelessly transmitting power may be a power transfer device for wirelessly transferring power to a wireless power reception apparatus or an electronic device 200 or may be a wireless charging device for wirelessly transferring power so that the battery of the electronic device 200 is charged. In some embodiments, the apparatus 100 may be implemented into various types of apparatuses for transferring power to the electronic device 200 that requires a power source in a contactless way.

The electronic device 200 is a device capable of operating using power wirelessly received from the apparatus 100 for wirelessly transmitting power, and may charge its battery using wirelessly received power. The electronic device 200 for wirelessly receiving power may include all types of electronic devices that may be carried, for example, smart phones, smart terminals, tablet PCs, multimedia terminals, keyboards, mouses, and input/output devices, such as video or audio-assistant devices.

The apparatus 100 for wirelessly transmitting power may wirelessly send power using an inductive coupling method based on an electromagnetic induction phenomenon according to a wireless power signal. That is, resonance is generated in the electronic device 200 in response to a wireless power signal transmitted by the apparatus 100 for wirelessly transmitting power, and power may be transmitted from the apparatus 100 for wirelessly transmitting power to the electronic device 200 in a contactless way in accordance with the resonant phenomenon. In accordance with an electromagnetic induction phenomenon, the magnetic field of a primary coil is changed by an AC current, an electric current is induced toward a secondary coil, and thus power is transferred.

If the intensity of an electric current flowing into the primary coil of the apparatus 100 for wirelessly transmitting power is changed, a magnetic field that passes through the primary coil (or a transmission (Tx) coil) is changed by the electric current. The changed magnetic field generates induced electromotive in a secondary coil (or a reception (Rx) coil) within the electronic device 200.

If the apparatus 100 for wirelessly transmitting power and the electronic device 200 are disposed so that the Tx coil of the apparatus 100 for wirelessly transmitting power and the Rx coil of the electronic device 200 are adjacent to each other and the apparatus 100 for wirelessly transmitting power controls the electric current of the Tx coil so that it is changed, the electronic device 200 supplies a power source to a load, such as a battery, using the electromotive induced into the Rx coil.

Efficiency of wireless power transfer using the inductive coupling method is influenced by the arrangement of the apparatus 100 for wirelessly transmitting power and the electronic device 200 and the distance therebetween. Accordingly, the apparatus 100 for wirelessly transmitting power may be configured to include a flat interface surface, the Tx coil may be disposed under the interface surface, and one or more electronic devices may be placed over the interface surface. If the space between the Tx coil disposed under the interface surface and the Rx coil disposed over the interface surface is sufficiently reduced, efficiency of wireless power transfer using the inductive coupling method can be improved.

A mark indicative of the location where the electronic device will be placed may be indicated in the interface surface. The mark may indicate the location of the electronic device so that the Tx coil disposed under the interface surface and the Rx coil disposed over the interface surface are properly arranged. A structure of a protruded shape for guiding the location of the electronic device may be formed on the interface surface. A magnetic material, such as a magnet, may be formed under the interface surface so that the Tx coil and the Rx coil are well arranged by an attractive force between the magnetic material and the magnetic material of another pole provided within the electronic device.

FIG. 2 is a conceptual diagram illustrating the configuration of a circuit in the power conversion unit of an apparatus for wirelessly transmitting power using an electromagnetic induction method.

The apparatus for wirelessly transmitting power may basically include a power source and a power conversion unit, including an inverter and a resonance circuit. The power source may be a voltage source or a current source. The power conversion unit converts power supplied by the power source into a wireless power signal and transfers the converted power to a reception apparatus. The wireless power signal is formed in a magnetic field or electromagnetic field form having a resonant characteristic, and the resonance circuit includes a coil for generating a wireless power signal.

The inverter converts a DC input into an AC waveform having a required voltage and frequency through a switching element and a control circuit. In FIG. 2, a full-bridge inverter has been illustrated, but other types of inverters, such as a half-bridge inverter, may be used.

The resonance circuit includes a Tx coil Lp for sending power using a magnetic induction method and a capacitor Cp. The transmission coil Lp and the capacitor Cp determine a basic resonant frequency for power transfer. The Tx coil forms a magnetic field corresponding to a wireless power signal depending on a change of an electric current, and may be implemented in a flat panel or solenoid form.

When the resonance circuit is driven by an AC current converted by the inverter, a magnetic field is formed in the Tx coil. The inverter generates an AC of a frequency close to the resonant frequency of the resonance circuit, thereby being capable of increasing transfer efficiency of the transmission apparatus. Transmission efficiency of the transmission apparatus may be changed by controlling the inverter.

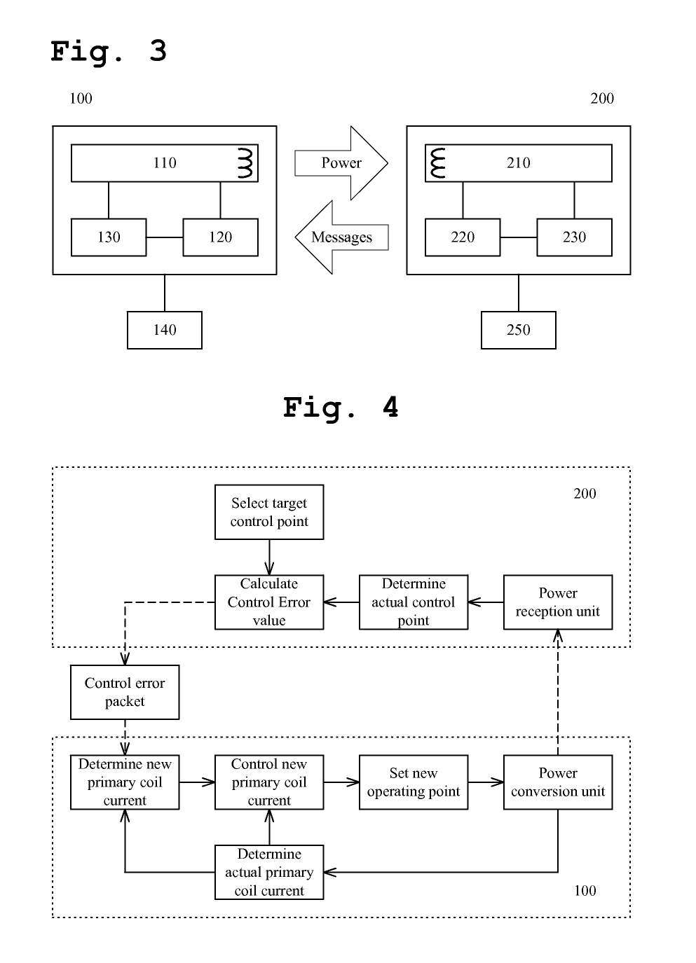

FIG. 3 illustrating the configuration for exchanging power and messages between the apparatus for wirelessly transmitting power and a reception apparatus.

A power conversion unit has only to send power one-sidedly regardless of the reception state of a reception apparatus. In order to send power according to the state of the reception apparatus, an element for receiving feedback related to the reception state of the reception apparatus needs to be configured in the apparatus for wirelessly transmitting power.

The apparatus 100 for wirelessly transmitting power may be configured to include a power conversion unit 110, a communication unit 120, a control unit 130, and a power source unit 140. An apparatus 200 for wirelessly receiving power may be configured to include a power reception unit 210, a communication unit 220, and a control unit 230, and may further include a load 250 to which received power will be supplied.

The power conversion unit 110 includes the inverter and resonance circuit of FIG. 2, and may be configured to further include a circuit for controlling characteristics, such as a frequency, a voltage, and a current that are used to form a wireless power signal.

The communication unit 120 is connected to the power conversion unit 110. The communication unit 120 may demodulate a wireless power signal modulated by the reception apparatus 200 for wirelessly receiving power using a magnetic induction method from the transmission apparatus 100, and may detect a power control message.

The control unit 130 may determine one or more of characteristics, such as the operating frequency, voltage, and current of the power conversion unit 110, based on a based on a message detected by the communication unit 120, and may control the power conversion unit 110 so that the power conversion unit 110 generates a wireless power signal suitable for the message. The communication unit 120 and the control unit 130 may be configured in a single module form.

The power reception unit 210 includes a matching circuit, including an Rx coil for generating induced electromotive in response to a change of a magnetic field generated by the Tx coil of the power conversion unit 110 and a capacitor. The power reception unit 210 may include a rectifier circuit for rectifying an AC current flowing into the Rx coil and outputting a DC current.

The communication unit 220 of the reception apparatus is connected to the power reception unit 210. The communication unit 220 may change a wireless power signal between the transmission apparatus 100 and the reception apparatus 200 by controlling the load of the power reception unit 210 in such a way as to control a resistive load in a DC and/or a capacitive load in an AC, and may send a power control message to the transmission apparatus 100.

The control unit 230 of the reception apparatus controls the elements of the reception apparatus 200. The control unit 230 may measure the output of the power reception unit 210 in a current or voltage form, may control the communication unit 220 based on the measured output, and may transfer a power control message to the transmission apparatus 100. The power control message may instruct the transmission apparatus 100 to start or terminate the transfer of a wireless power signal, and may also control the transmission apparatus 100 so that it controls the characteristics of the wireless power signal.

A wireless power signal formed by the power conversion unit 110 of the transmission apparatus 100 is received by the power reception unit 210. The control unit 230 controls the communication unit 220 so that it modulates the wireless power signal. The control unit 230 may perform a modulation process for changing the amount of power received from the wireless power signal by changing reactance of the communication unit 220. If the amount of power received from the wireless power signal is changed, the current and/or voltage of the power conversion unit 110 that forms the wireless power signal is changed. The communication unit 120 of the transmission apparatus 100 may detect a change of the current and/or voltage of the power conversion unit 110 and perform a demodulation process.

The control unit 230 of the reception apparatus 200 may generate a packet including a message to be delivered to the transmission apparatus 100, and may modulate a wireless power signal so that it includes the packet. The control unit 130 of the transmission apparatus 100 may obtain a power control message by decoding the packet extracted through the communication unit 120. In order to control received power, the control unit 230 may send a message that requests a change of the characteristics of the wireless power signal based on the amount of power received through the power reception unit 210.

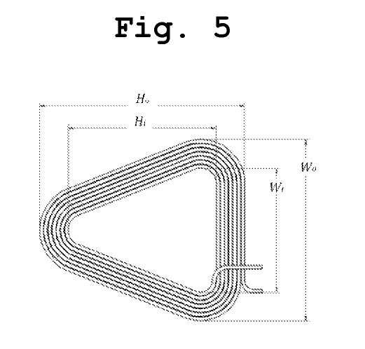

FIG. 4 is a block diagram illustrating a loop for controlling the transfer of power between the transmission apparatus and the reception apparatus.

An electric current is induced from the power reception unit 210 of the reception apparatus 200 in response to a change of a magnetic field generated by the power conversion unit 110 of the transmission apparatus 100, and power is transmitted. The control unit 230 of the reception apparatus selects a required control point, that is, a point at which a required current and/or voltage is output, and determines an actual control point at which power received through the power reception unit 210 is controlled.

While the power is transmitted, the control unit 230 of the reception apparatus calculates a control error value using the required control point and the actual control point, and may take a difference between two output voltages or electric currents, for example, as the control error value. The control unit 230 may determine the control error value so that it becomes, for example a minus value if small power is required to reach the required control point and determine the control error value so that it becomes a plus value if great power is required to reach the required control point. The control unit 230 of the reception apparatus may generate a packet including the control error value calculated using a method of changing reactance of the power reception unit 210 over time and send the packet to the apparatus 100 through the communication unit 220.

The communication unit 120 of the transmission apparatus 100 demodulates the packet included in a wireless power signal modulated by the reception apparatus 200 and detects a message. In this case, the communication unit 120 may demodulate a control error packet including the control error value.

The control unit 130 of the transmission apparatus 100 may obtain the control error value by decoding the control error packet extracted through the communication unit 120, and may determine a new current value at which the transmission apparatus 100 can transmits a power that the reception apparatus 200 wants, using the control error value and an actual current value flowing into the power conversion unit 110.

If a system is stabilized in the process of receiving the control error packet from the reception apparatus, the control unit 130 of the transmission apparatus 100 controls the power conversion unit 110 so that the actual current value flowing into the Tx coil becomes a new current value and a new operating point, that is, the amount, frequency, and duty ratio of an AC voltage applied to the Tx coil reaches a new value, and continues to maintain a new operating point so that the reception apparatus 200 additionally exchange pieces of control information or state information.

An interaction between the transmission apparatus 100 and the reception apparatus 200 is performed through four steps, including selection, ping, identification & configuration, and power transfer. In the selection step, the transmission apparatus 100 discovers the object placed on an interface surface. In the ping step, whether the object includes the reception apparatus 200 is checked. In the identification & configuration step, power is prepared to be sent to the reception apparatus 200, proper information is received from the reception apparatus 200, and a power transfer contract is made between the transmission apparatus 100 and the reception apparatus 200. In the power transfer step, the power is actually transmitted to the reception apparatus 200 through the interaction between the transmission apparatus 100 and the reception apparatus 200.

In the ping step, the reception apparatus 200 sends a signal strength packet (SSP) indicative of the degree of magnetic flux coupling between the Tx coil and the Rx coil to the transmission apparatus 100 through the modulation of a resonant waveform. The SSP may become a voltage value rectified by the reception apparatus 200.

In the identification & configuration step, the reception apparatus 200 sends an identification packet, including information about the version, manufacturer code, and device ID of the reception apparatus 200, and a configuration packet, including information about maximum power and a power transfer method of the reception apparatus 200, to the apparatus 100.

In the power transfer step, the reception apparatus 200 sends, to the apparatus 100, a control error packet (CEP) indicative of a difference between an operating point at which the reception apparatus 200 receives a power signal and an operating point determined in the power transfer contract and a received power packet (RPP) indicative of the mean value of power received by the reception apparatus 200 through the interface surface.

Each of sensing units (not illustrated) included in the power conversion unit 110 of the apparatus 100 extracts a packet from a change of a resonant waveform. The control unit 130 may obtain a message by decoding the extracted packet, may control the power conversion unit 110 based on the message, and may wirelessly transmit power requested by the reception apparatus 200 while changing a power transfer characteristic.

In a method of wirelessly transferring power according to the inductive coupling method, efficiency is less influenced by a frequency characteristic, but is influenced by the arrangement of the apparatus 100 and the reception apparatus 200 and the distance therebetween.

A region to which a wireless power signal can reach may be basically divided into two regions. The two regions include an active region and a detection region. The part of the interface surface through which a magnetic field of high efficiency may pass when the transmission apparatus 100 wirelessly transmits power to the reception apparatus 200 may be called the active region. A region in which the apparatus 100 may detect the presence of the reception apparatus 200 may be called the detection region.

The control unit 130 of the transmission apparatus 100 may detect whether the reception apparatus 200 has been disposed in the active region or the detection region or whether the reception apparatus 200 has been removed from the active region or the detection region. In this case, the control unit 130 may detect whether the reception apparatus 200 has been disposed in or removed from the active region or the detection region using a wireless power signal generated by the power conversion unit 110 or using a separate sensor. For example, the control unit 130 of the transmission apparatus 100 may detect the presence of the reception apparatus 200 by monitoring whether the characteristics of power for forming the wireless power signal of the power conversion unit 110 has been changed because the wireless power signal is influenced by the reception apparatus 200 present in the detection region. The control unit 130 of the transmission apparatus 100 may perform a process of identifying the reception apparatus 200 or may determine whether or not to start the wireless transfer of power based on a result of the detection of the presence of the reception apparatus 200.

The power conversion unit 110 of the transmission apparatus 100 may further include a location determination unit. The location determination unit may move or rotate the Tx coil in order to improve efficiency of wireless power transfer according to the inductive coupling method. In particular, the location determination unit may be used when the reception apparatus 200 is not present in the active region of the transmission apparatus 100.

The location determination unit may be configured to include a driving unit configured to move the Tx coil so that the distance between the centers of the Tx coil of the apparatus 100 and the Rx coil of the reception apparatus 200 becomes a specific range or to rotate the Tx coil so that the centers of the Tx coil and the Rx coil are overlapped. To this end, the apparatus 100 may further include a sensor or detection unit configured to detect the location of the reception apparatus 200. The control unit 130 of the transmission apparatus 100 may control the location determination unit based on information that is received from the sensor of the detection unit and that is about the location of the reception apparatus 200.

Alternatively, the control unit 130 of the transmission apparatus 100 may receive control information about the arrangement of the transmission apparatus 100 and the reception apparatus 200 and the distance therebetween through the communication unit 120, and may control the location determination unit based on the control information.

Furthermore, the apparatus 100 may be configured to include a plurality of transmission coils in order to improve transfer efficiency selectively using some coils that belong to the plurality of transmission coils and that are suitably arranged with the Rx coil of the reception apparatus 200. In this case, the location determination unit may determine that which of the plurality of transmission coils will be used to send power.

A single transmission coil or a combination of one or more transmission coils for forming a magnetic field passing through the active region may be called a primary cell. The control unit 130 of the transmission apparatus 100 may detect the location of the reception apparatus 200, may determine the active region based on the detected location, may connect a transmission module configured to form a primary cell corresponding to the active region, and may perform control so that a corresponding Tx coil or corresponding Tx coils of the transmission module and a corresponding Rx coil of the reception apparatus 200 are subject to inductive coupling.

The reception apparatus 200 may be embedded in an electronic device, such as a smart phone, a smart phone including a multimedia playback terminal, or a smart device. The transmission apparatus requires a wide active region because the electronic device is placed on the interface of the apparatus 100 in an irregular direction or at an irregular location vertically or horizontally.

If a plurality of transmission coils is used to widen the active region, driving circuits equal to the number of Tx coils are required, and control of the plurality of transmission coils is complicated. Accordingly, a cost for the transmission apparatus 100, that is, a wireless charger, is increased when the transmission apparatus 100 is commercialized. Furthermore, if a method of changing the locations of the Tx coils is used in order to widen the active region, there is a problem in that volume and weight are increased and a manufacture cost is increased because a transfer mechanism for moving the locations of the Tx coils must be included.

It will be effective if there is a method of widening the active region using only a single Tx coil whose location has been fixed. If the size of the Tx coil is increased, magnetic flux densities per unit area of the Tx coil are decreased, the active region is not increased as expected because a magnetic coupling force between the Tx and Rx coils is weakened, and transfer efficiency is also deteriorated.

As described above, it is important to determine the shape and size of the Tx coil in order to widen the active region and improve transfer efficiency.

FIG. 5 illustrates a transmission coil to which an embodiment of the present invention is applied.

The active region of the Tx coil needs to be secured and enlarged in order to guarantee specific charging efficiency in the state in which an electronic device including the reception apparatus has been placed in several postures, that is, has been lengthily upright horizontally or has been lengthily upright vertically, in a charger including the transmission apparatus.

The Tx coil in accordance with an embodiment of the present invention is formed in such a manner that a wire is wound so that an electric current is converted into a magnetic flux, and may be formed of a single layer in a triangular form as illustrated in FIG. 5. Specifically, the corners of the triangle of the Tx coil may be rounded. In this case, the Tx coil is wound along the sides of the isosceles triangle in the same plane, and the height of the isosceles triangle may be longer than the base.

The Tx coil in accordance with an embodiment of the present invention has a perimeter height Hₒ of 52±0.5 mm, an inside height Hᵢ of 34±0.5 mm, a perimeter width Wₒ of 46±0.5 mm, an inside width Wᵢ of 28±0.5 mm, a thickness d_{c} of 1.1±0.3 mm, and a diameter of 0.8 mm. The wire of the Tx coil may be wound 8 times in a single layer. Such a wire is summarized as in Table 1 below.

TABLE 1

| Symbol | Hₒ | Hᵢ | Wₒ | Wᵢ | d_{c} |
|---|---|---|---|---|---|
| Value | 52 ± 0.5 | 34 ± 0.5 | 46 ± 0.5 | 28 ± 0.5 | 1.1 ± 0.3 |
| (mm) | | | | | |

The transmission apparatus including a single triangle coil having the active region of the same level or higher as a plurality of coils may be implemented through the shape and dimensions of the single triangle coil even without using a plurality of coils.

Furthermore, a Tx coil according to the existing A16 design has a perimeter height Hₒ of 59±0.5 mm, an inside height Hᵢ of 43±0.5 mm, a perimeter width Wₒ of 52±0.5 mm, an inside width Wᵢ of 36±0.5 mm, and a thickness d_{c} of 1.1±0.3 mm, and the wire of the Tx coil is wound 7 times in a single layer.

It was found that the Tx coil in accordance with an embodiment of the present invention had an expanded chargeable region (i.e., improved efficiency of 3% compared to the coil A16), had an improved efficiency characteristic compared to the coil A16 and thus less power consumption and excellent heat dissipation characteristics (i.e., an improved heat dissipation characteristic of 3° C. compared to the coil A16), was capable of handling an Rx coil of a smaller size compared to the coil A16 (i.e., capable of handling a wireless power consortium (WPC) compatibility test configuration D), had an improved oscillating characteristic in the reception apparatus compared to the coil A16, and had an improved charging reattempt phenomenon through improved compatibilities with the reception apparatus compared to the coil A16, compared to the Tx coil of the existing A16 design.

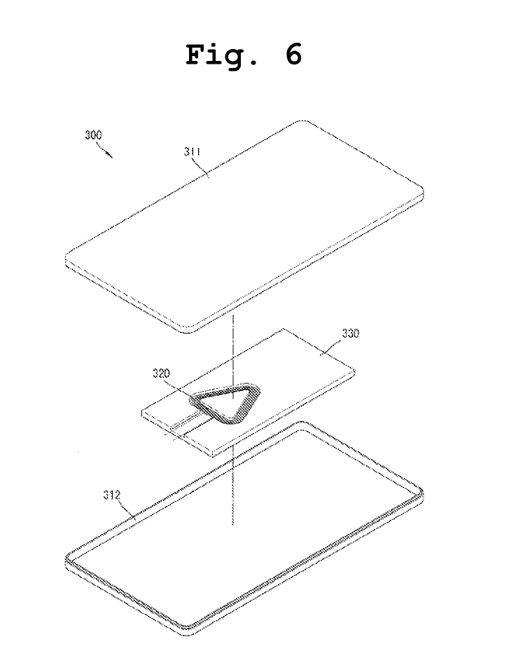

FIG. 6 is an exploded perspective view of a charger including the Tx coil of FIG. 5.

Referring to FIG. 6, the charger 300 includes the transmission apparatus configured to provide induced power. An electronic device including the reception apparatus, that is, the object to be charged, is placed on a top surface of the charger 300. A seated surface having an operation region may be formed on the top surface of the charger 300. When the electronic device is placed on the seated surface, the charger may detect such a placement and start wireless charging.

The charger 300 may include the Tx coil 320 of FIG. 5 disposed between a front casing 311 and a rear casing 312 and a shielding unit 330 disposed under the Tx coil 320 and configured to surround the Tx coil 320. That is, the shielding unit 330 may be formed between the rear casing 312 and Tx coil 320 of the charger 300, and at least part of the shielding unit 330 may be formed to exceed the perimeter of the Tx coil 320.

The shielding unit 330 can prevent elements, such as a microprocessor and memory mounted on a circuit board (not illustrated), from being subject to an electromagnetic influence according to the operation of the Tx coil 320, and can prevent the Tx coil 320 from being subject to an electromagnetic influence according to the operations of elements mounted on the circuit board. The shielding unit 330 may be made of stainless or titanium that does not require plating.

The charger 300 may be configured to have the power conversion unit including the Tx coil, the communication unit, the control unit, and the power source unit included in a single body or may be configured to be divided into a first body configured to have the Tx coil 320 and the shielding unit 330 mounted thereon and a second body connected to the first body and configured to include the power conversion unit for controlling the operation of the Tx coil 320, the communication unit, the control unit, and the power source unit.

Furthermore, an output unit, such as a display or a speaker, a user input unit, a socket configured to supply a power source, and an interface to which an external device is coupled, may be disposed in the body of the charger 300. The display may be formed on the top surface of the front casing 311, and the user input unit and the socket may be disposed on the side of the body.

Accordingly, a chargeable region can be expanded because the operation region is additionally secured, and thus power can be stably transmitted.

Furthermore, there are advantages in that transfer efficiency can be improved, power consumption can be reduced, a heat dissipation characteristic can be improved, and the generation of excessive heat can be prevented.

It is evident to those skilled in the art that the present invention is not limited to the aforementioned embodiments and may be modified and changed in various ways without departing from the spirit and scope of the present invention. Accordingly, such modifications or changes should be construed as belonging to the claims of the present invention.

What is claimed is:

1. An apparatus for wirelessly transmitting power, comprising:
a transmission coil configured to change a magnetic field in response to an AC current;
a shielding unit configured to restrict a propagation of the magnetic field generated from the transmission coil; and
a casing configured to surround the transmission coil and the shielding unit,
wherein the transmission coil is formed in a single layer form by winding a wire along sides of an isosceles triangle having a height greater than a base in an identical plane, and
the transmission coil has a perimeter height of 52±0.5 mm, an inside height of 34±0.5 mm, a perimeter width of 46±0.5 mm, an inside width of 28±0.5 mm, and a thickness of 1.1±0.3 mm.

2. The apparatus of claim 1, wherein the transmission coil is formed by winding the wire on the sides of the isosceles triangle eight times.

3. The apparatus of claim 1, wherein at least part of the shielding unit is configured to exceed a perimeter of the transmission coil.

4. The apparatus of claim 1, wherein the shielding unit is formed between the transmission coil and the casing.

5. A transmission coil configured to change a magnetic field in response to an AC current and wirelessly send power,
wherein the transmission coil is formed in a single layer form by winding a wire along sides of an isosceles triangle having a height greater than a base in an identical plane,
the transmission coil has a perimeter height of 52±0.5 mm, an inside height of 34±0.5 mm, a perimeter width of 46±0.5 mm, an inside width of 28±0.5 mm, and a thickness of 1.1±0.3 mm, and
the wire is wound on the sides of the isosceles triangle eight times.
